(19) United States
(12) Patent Application Publication
(10) Pub. No.: US 2015/0352957 A1
(43) Pub. Date: Dec. 10, 2015

(54) Secondary Battery and Secondary Battery Module

(71) Applicant: HITACHI AUTOMOTIVE SYSTEMS, LTD., Hitachinaka-shi, Ibaraki (JP)

(72) Inventors: Tsubasa KUWANO, Hitachinaka-shi (JP); Hisao TAZUME, Hitachinaka-shi (JP)

(73) Assignee: Hitachi Automotive Systems, Ltd., Hitachinaka-shi, Ibaraki (JP)

(21) Appl. No.: 14/759,721

(22) PCT Filed: Feb. 13, 2013
(86) PCT No.: PCT/JP2013/053348

§ 371 Date: Jul. 8, 2015

(51) Int. Cl. B60L 3/04; H02J 7/00; H01M 10/44

(52) U.S. Cl. CPC B60L 3/04; H01M 10/44; H02J 7/0068; H01M 2010/4271

(57) ABSTRACT

Provided are a secondary battery and a secondary battery module that can decrease energy of a power generating element of the secondary battery without fail even if, for example, impact of a collision damages a controller controlling charge/discharge of a secondary battery cell or disconnects a wiring connecting the controller and the secondary battery cell. The secondary battery includes a secondary battery cell and a cell controller controlling charge/discharge of the secondary battery cell. The cell controller causes discharge of the secondary battery cell when a collision or a collision probability of a movable object mounting the secondary battery is detected.

### TECHNICAL FIELD

The present invention relates to a secondary battery and a secondary battery module, and for example, to a secondary battery and a secondary battery module mounted on a movable object such as a vehicle.

### BACKGROUND ART

A large-capacity and high-output secondary battery module is used for vehicles such as hybrid electric vehicles (HEV) driving power of which is partially assisted by an electric motor and electric vehicles (EV), for example. Such a secondary battery module is formed of multiple secondary batteries connected with one another in series or in parallel.

When a collision of a vehicle mounting, for example, a fully charged second battery module with high energy occurs to render the vehicle unable to travel, a worker or the like needs to take measures such as removal of the secondary battery module from the vehicle after the collision, for example. For this reason, in the relevant art, development of a secondary battery module that can be handled safely in a vehicle after the collision, for example, has been demanded.

Patent Literature 1 discloses a conventional technique of such secondary battery module. The battery system disclosed by Patent Literature 1 is a system including means of causing electric discharge in case of operation of current cutoff means that can cut off electric conduction by detecting a battery's state.

### CITATION LIST

### Patent Literature

Patent Literature 1: JP Patent Publication (Kokai) No. 2008-234903 A

### SUMMARY OF INVENTION

### Technical Problem

In the battery system disclosed by Patent Literature 1, if a movable object mounting the battery system causes a collision accident to enter an abnormal state in which, for example, the battery is in an overcharged state, supply of current to the outside can be cut off, and further, energy of a power generating element contained in the battery can be decreased.

However, the battery system disclosed by Patent Literature 1 has problems in which discharge of the battery cell becomes impossible, when, for example, impact of a collision damages a controller that controls charge/discharge of the battery cell included in the battery system, or disconnects a wiring that connects the controller and the battery cell.

The present invention has been made in view of the aforementioned problem, and the object thereof is to provide a secondary battery and a secondary battery module that can decrease energy of a power generating element of the secondary battery without fail even if, for example, impact of a collision damages a controller that controls charge/discharge of a secondary battery cell included in the secondary battery module or disconnects a wiring that connects the controller and the secondary battery cell.

### Solution to Problem

To solve the aforementioned problem, a secondary battery of the present invention includes a secondary battery cell and a cell controller controlling charge/discharge of the secondary battery cell, wherein the cell controller causes discharge of the secondary battery cell when a collision or a collision probability of a movable object mounting the secondary battery is detected.

A secondary battery module of the present invention includes: an assembled battery having multiple secondary batteries connected with one another in series and/or in parallel, the secondary battery having a secondary battery cell and a cell controller controlling charge/discharge of the secondary battery cell; and a battery control unit controlling the assembled battery, wherein when a collision or a collision probability of a movable object mounting the secondary battery module is detected, the battery control unit sends a discharge start command to the cell controllers of the secondary batteries included in the assembled battery, and the cell controller causes discharge of the secondary battery cell of the corresponding secondary battery in accordance with the discharge start command.

### Advantage Effects of Invention

In the present invention, when a collision or a collision probability of a movable object mounting a secondary battery or a secondary battery module is detected, a cell controller provided for a secondary battery cell causes discharge of the secondary battery cell. Thus, even if, for example, impact of the collision damages a controller controlling charge/discharge of the secondary battery cell or disconnects a wiring connecting the controller and the secondary battery cell, energy of a power generating element of the secondary battery can be decreased without fail. A worker or the like can safely handle the secondary battery in the movable object after the collision.

Other problems, configurations and effects other than those described above will be clear in the following descriptions of embodiments.

### BRIEF DESCRIPTION OF DRAWINGS

FIG. 1 is an entire structure diagram illustrating a basic structure of a movable object including a secondary battery module of Embodiment 1 of the present invention.

FIG. 2 is a perspective view illustrating a basic structure of a secondary battery included in the secondary battery module illustrated in FIG. 1.

FIG. 3 is a perspective view illustrating a basic structure of the secondary battery module illustrated in FIG. 1.

FIG. 4 is an internal structure diagram illustrating an internal structure of the secondary battery module illustrated in FIG. 3.

FIG. 5 is a circuit diagram illustrating an example of a discharge stop device illustrated in FIG. 4.

FIG. 6 is an internal structure diagram illustrating an internal structure of the secondary battery illustrated in FIG. 4.

FIG. 7A illustrates an example of an emergency discharge start command and an emergency discharge stop command received by a CC illustrated in FIG. 6.

FIG. 7B illustrates another example of an emergency discharge start command received by the CC illustrated in FIG. 6.

FIG. 7C illustrates another example of an emergency discharge stop command received by the CC illustrated in FIG. 6.

FIG. 8 is a circuit diagram illustrating an example of a resistance circuit illustrated in FIG. 6.

FIG. 9 is a schematic diagram schematically illustrating a flow of signal processing by a BCU illustrated in FIG. 4.

FIG. 10 is a schematic diagram schematically illustrating a flow of signal processing by a CC illustrated in FIG. 4.

FIG. 11 illustrates an example of discharge processing of the secondary battery cell in time series in a case where a collision of a movable object is detected.

FIG. 12 illustrates another example of discharge processing of the secondary battery cell in time series in a case where a collision of a movable object is detected.

FIG. 13 is a flow diagram illustrating a flow of discharge processing of the secondary battery cell.

FIG. 14 is an internal structure diagram illustrating an internal structure of a secondary battery module of Embodiment 2 of the present invention.

FIG. 15 is an internal structure diagram illustrating an internal structure of a secondary battery module of Embodiment 3 of the present invention.

FIG. 16 is an internal structure diagram illustrating an internal structure of a secondary battery module of Embodiment 4 of the present invention.

### DESCRIPTION OF EMBODIMENTS

Hereinafter, descriptions will be given of embodiments of a secondary battery and a secondary battery module of the present invention, with reference to the drawings. In the following descriptions, the embodiments in which the secondary battery and the secondary battery module are applied to a movable object of a hybrid electric vehicle (HEV) are mainly exemplified. However, the secondary battery and the secondary battery module of the present invention can be applied also to hybrid trains or electric vehicles (EV), for example.

### Embodiment 1

FIG. 1 illustrates a basic structure of a movable object including a secondary battery module of Embodiment 1 of the present invention.

In the illustrated movable object 1, axles 3 connected mechanically with respective drive wheels 2 are connected with a differential gear 4 and an input shaft of the deferential gear 4 is connected with a transmission 5. The transmission 5 is connected with a driving power switching device 8 which switches driving power of an engine (internal combustion engine) 6 and that of a motor generator 7.

The motor generator 7 is electrically connected with a secondary battery module 11, which is a power source device, via a power inverting device (inverter) 9. The secondary battery module 11 is a vehicle-mounted drive power supply device which charges power regenerated by the motor generator 7 as driving power while discharges power necessary for driving the movable object 1 with use of the motor generator 7 as a generator. The secondary battery module 11 includes an assembled battery 14 having several tens of secondary batteries such as lithium ion secondary batteries, which are connected in series and/or in parallel to have a rated voltage of 100 V or more, for example, and a battery control unit (BCU) 10 controlling the assembled battery 14. The BCU 10 operates a current command value based on a torque command value output from a host control device (not illustrated) and operates a voltage command value based on the difference between the operated current command value and an actual value of current passing through the power inverting device 9. In accordance with the operated voltage command value, the BCU 10 supplies power from the assembled battery 14 to the power inverting device 9.

In the movable object 1, a collision sensor (for example, acceleration sensor) detecting a collision of the movable object 1 and a discharge stop device 13 stopping discharge of the secondary battery module 11 are arranged. The BCU 10 of the secondary battery module 11 is connected with the collision sensor 12 and the discharge stop device 13.

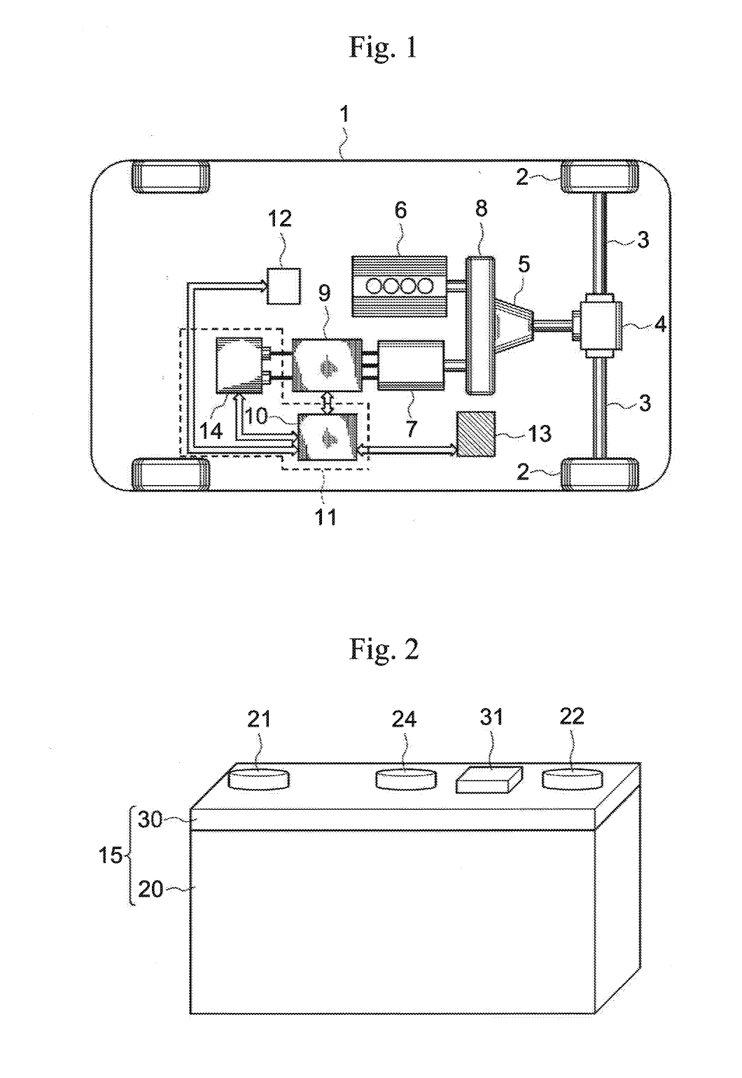

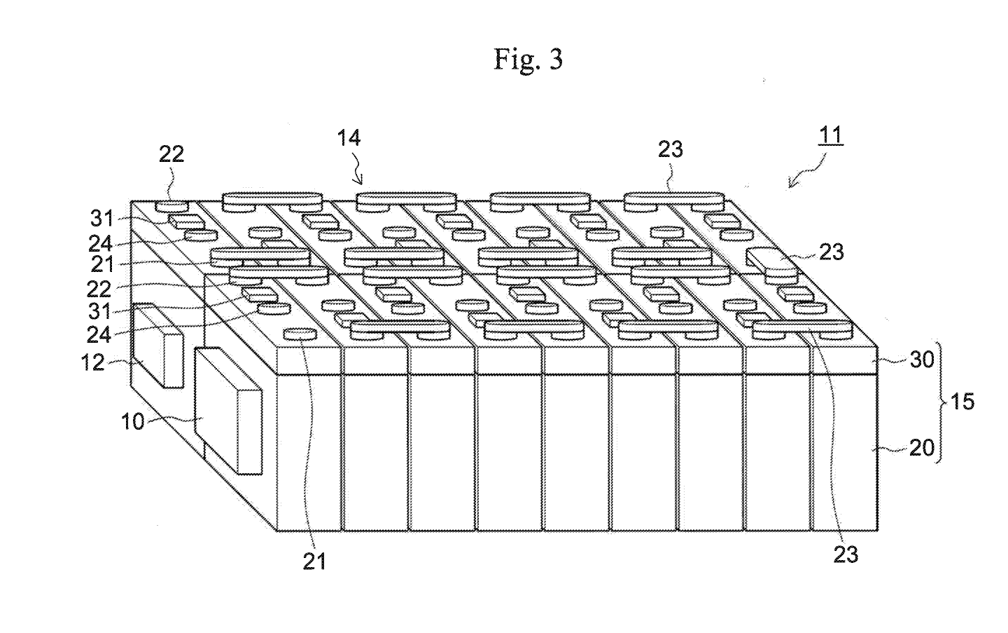

FIG. 2 illustrates a basic structure of the secondary battery included in the secondary battery module illustrated in FIG. 1. FIG. 3 illustrates a basic structure of the secondary battery module illustrated in FIG. 1. In the example illustrated in FIG. 3, the collision sensor 12 is attached to part of a secondary battery 15 included in the secondary battery module 11.

As illustrated in FIG. 2, the secondary battery 15 mainly includes a secondary battery cell 20 and a cell controller (CC) 30 controlling charge/discharge of the secondary battery cell 20. On the upper part of the secondary battery 15, a positive electrode 21 and a negative electrode 22 of the secondary battery cell 20 project out through the CC 30, and a cleavage valve 24 that decreases the pressure in the secondary battery cell 20 in a case of an internal pressure abnormality of the secondary battery cell 20 is arranged. On the upper part of the CC 30, a communication connector 31 communicating with the BCU 10 is arranged. The CC 30 may communicate with the BCU 10 via wireless communication.

As illustrated in FIG. 3, the secondary battery module 11 is formed of the assembled battery 14 having the plurality of the secondary batteries 15, which is illustrated in FIG. 2, connected with one another and the BCU 10 controlling the assembled battery 14. Between the adjacent secondary batteries 15, the negative electrode 22 of one of the secondary batteries 15 and the positive electrode 21 of the other secondary battery 15 are electrically connected in series via a bus bar 23. The bus bar 23 is connected with the negative electrode 22 and the positive electrode 21 of the respective secondary batteries 15 by welding, a bolt joint, etc. The BCU 10 acquires, for example, a battery temperature or a current value of the secondary battery module 11, a cell voltage of each secondary battery cell 20 and the like.

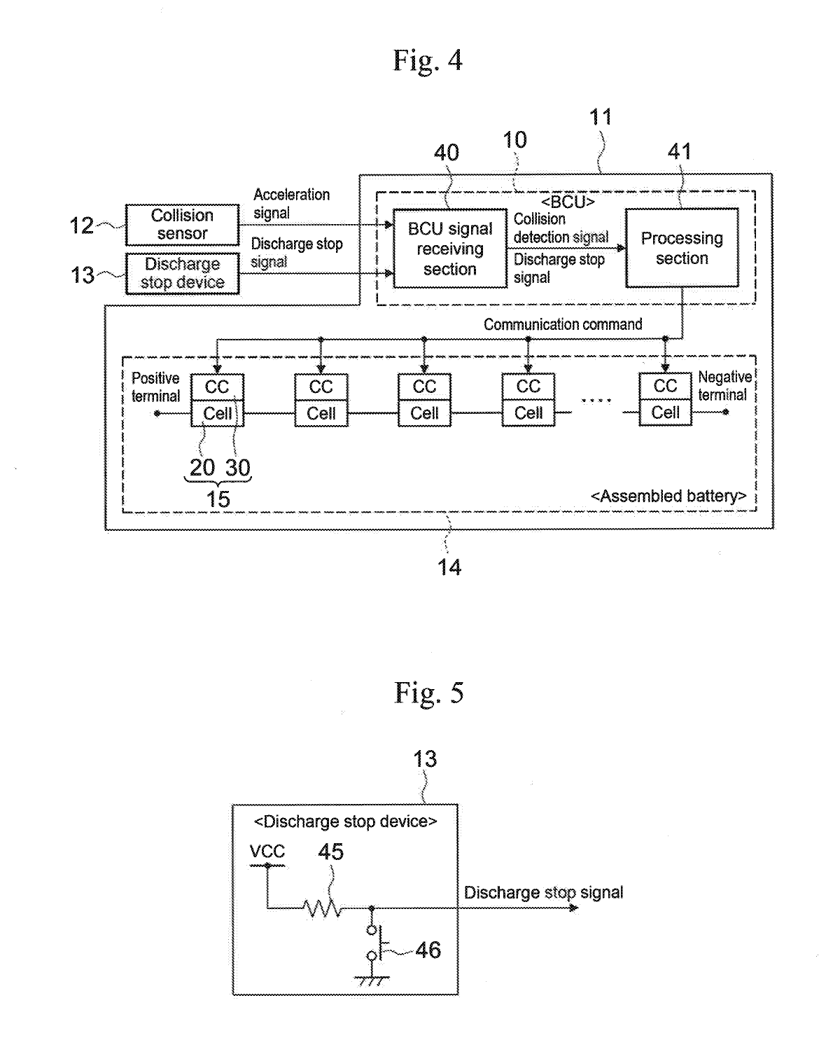

FIG. 4 illustrates an internal structure of the secondary battery module illustrated in FIG. 3.

As illustrated, the BCU 10 included in the secondary battery module 11 includes a BCU signal receiving section 40 receiving a signal (e.g., an acceleration signal) from the collision sensor 12 and a discharge stop signal from the discharge stop device 13 and a processing section 41 sending a communication command (e.g., an emergency discharge start command or an emergency discharge stop command) to the CCs 30 of the secondary batteries 15.

The BCU signal receiving section 40 of the BCU 10 receives a signal output from the collision sensor 12 and determines whether a collision of the movable object 1 has occurred (e.g., a collision rendering the movable object 1 unable to travel) based on the signal. If the BCU signal receiving section 40 determines that a collision of the movable object 1 has occurred, the BCU signal receiving section 40 sends a collision detection signal to the processing section 41. The processing section 41 having received the collision detection signal from the BCU signal receiving section 40 sends an emergency discharge start command to the CCs 30 of the secondary batteries 15. The CCs 30 having received the emergency discharge start command from the processing section 41 start discharge of the corresponding secondary battery cells 20.

The BCU signal receiving section 40 of the BCU 10 receives a discharge stop signal which is output from the discharge stop device 13 in accordance with, for example, switching operation of a driver, a worker or the like and sends the discharge stop signal to the processing section 41. The processing section. 41 having received the discharge stop signal from the BCU signal receiving section 40 sends an emergency discharge stop command to the CCs 30 of the secondary batteries 15. The CCs 30 having received the emergency discharge stop command from the processing section 41 stop discharge of the corresponding secondary battery cells 20.

FIG. 5 illustrates an example of the discharge stop device illustrated in FIG. 4.

As illustrated, in the discharge stop device 13, a VCC, for example, supplied from the BCU 10 is connected with a ground via a resistance element 45 and a discharge stop switch 46. One end of the discharge stop switch 46 at the resistance element 45 side is connected with the BCU signal receiving section 40 of the BCU 10. After detection of a collision of the movable object 1 and start of discharge of the secondary battery cells 20 as in the aforementioned manner, for example, the driver, the worker or the like may stop discharge of the secondary battery cells 20 (for example, the driver, the worker or the like may determine damage of the movable object 1 caused by the collision is small). In this case, the driver, the worker or the like can stop discharge of the secondary battery cells 20 by operating (e.g., pressing) the discharge stop switch 46 to send a discharge stop signal from the discharge stop device 13 to the BCU 10.

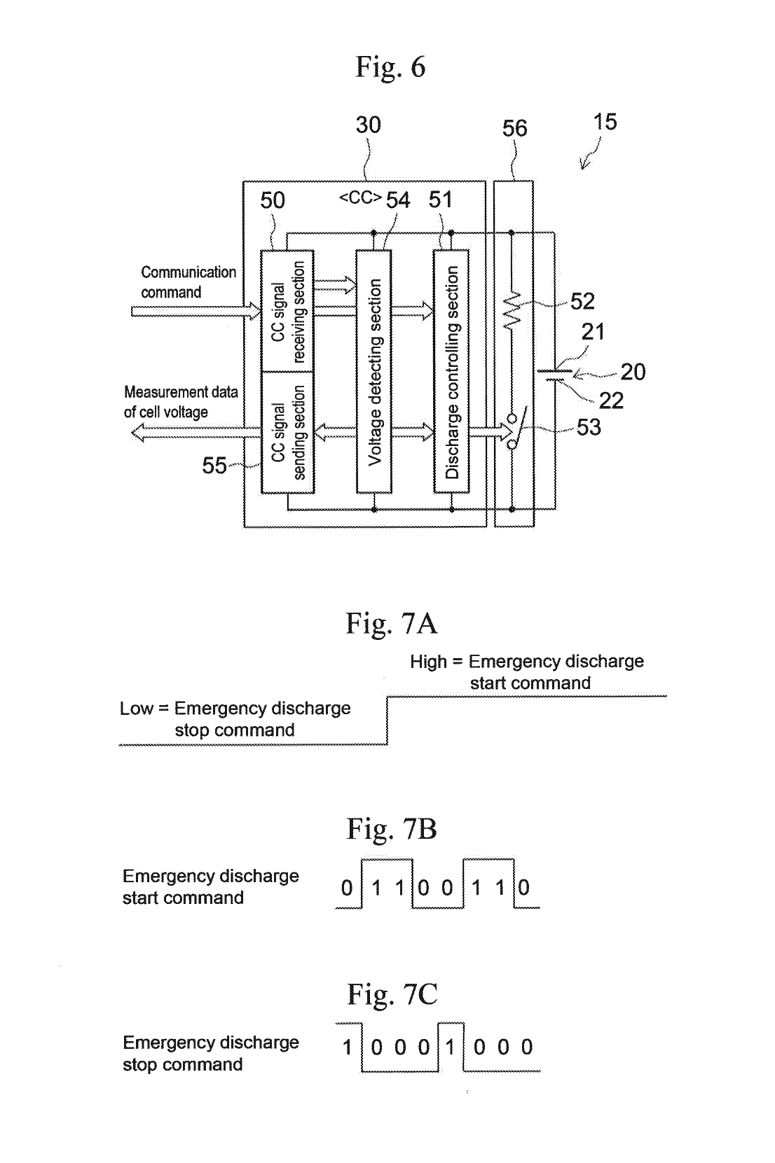

FIG. 6 illustrates an internal structure of the secondary battery illustrated in FIG. 4.

As illustrated, the secondary battery 15 mainly includes the secondary battery cell 20 and the CC 30. The secondary battery cell 20 is electrically connected with the CC 30. The secondary battery cell 20 supplies the CC 30 with driving power. The secondary battery 15 further includes a resistance circuit 56 including a discharge resistor 52 and a discharge switch 53. When the discharge switch 53 is in a closed state, current passes through the positive electrode 21 of the secondary battery cell 20, the discharge resistor 52, the discharge switch 53, and then the negative electrode 22 of the secondary battery cell 20 in this order. Thus, discharging the secondary battery cell 20 is performed.

The CC 30 included in the secondary battery 15 includes a CC signal receiving section 50 receiving a communication command from the BCU 10, a discharge controlling section 51 controlling the open state or closed state of the aforementioned discharge switch 53 of the resistance circuit 56, a voltage detecting section 54 measuring a cell voltage of the secondary battery cell 20 and a CC signal sending section 55 sending a cell voltage of the secondary battery cell 20 measured by the voltage detecting section 54 to the BCU 10.

When no collision of the movable object 1 has been detected (in a normal operation mode), the CC signal receiving section 50 of the CC 30 receives a communication command from the BCU 10 and the voltage detecting section 54 measures a cell voltage of the secondary battery cell 20 in accordance with the received communication command or the discharge controlling section 51 adjusts a capacity of the secondary battery cell 20 and the CC signal sending section 55 sends the measurement data of a cell voltage of the secondary battery cell 20 to the BCU 10.

After detection of a collision of the movable object 1 (in an emergency discharge mode), the CC signal receiving section 50 of the CC 30 receives an emergency discharge start command from the BCU 10 and the discharge controlling section 51 brings the discharge switch 53 of the resistance circuit 56 to the closed state to cause discharge of the secondary battery cell 20 in accordance with the received emergency discharge start command. The discharge controlling section 51 keeps the discharge switch 53 of the resistance circuit 56 in the closed state until the CC signal receiving section 50 receives an emergency discharge stop command from the BCE 10.

Overdischarge of a lithium ion secondary battery, for example, generally causes deterioration in its battery performance. Thus, the voltage detecting section 54 periodically measures a cell voltage of the secondary battery cell 20. If the cell voltage of the secondary battery cell 20 decreases to a predetermined value or less after start of discharge of the secondary battery cell 20, the discharge controlling section 51 brings the discharge switch 53 of the resistance circuit 56 to the open state to stop the discharge of the secondary battery cell 20.

If the CC signal receiving section 50 of the CC 30 receives an emergency discharge stop command from the BCU 10 after receiving the emergency discharge start command from the BCU 10 and starting discharge of the secondary battery cell 20, the discharge controlling section 51 brings the discharge switch 53 of the resistance circuit 56 to the open state to stop the discharge of the secondary battery cell 20 and to return to the normal operation mode.

FIGS. 7A to 7C illustrate an example of an emergency discharge start command and an emergency discharge stop command received by the CC illustrated in FIG. 6.

As illustrated in FIG. 7A, an emergency discharge start command and an emergency discharge stop command can use a signal waveform in which a low-state signal is the emergency discharge stop command and a high-state signal is the emergency discharge start command. In this case, the BCU 10 sends a low-state signal to the CC 30 until detection of a collision of the movable object 1. After detection of a collision of the movable object 1, the BCU 10 sends a high-state signal as an emergency discharge start command to the CC 30. Further, if for example, the driver, the worker or the like operates the discharge stop switch 46 of the discharge stop device 13, the BCU 10 sends a low-state signal as an emergency discharge stop command to the CC 30.

As illustrated in FIGS. 7B and 7C, an emergency discharge start command and an emergency discharge stop command can also use a predetermined data pattern by using digital communication that is typified by LIN communication and SPI communication. In this case, if a collision of the movable object 1 is detected, the BCU 10 sends a data pattern, e.g., “01100110” (binary number) as an emergency discharge start command to the CC 30. Further, if for example, the driver, the worker or the like operates the discharge stop switch 46 of the discharge stop device 13, the BCU 10 sends a data pattern, e.g., “10001000” (binary number) as an emergency discharge stop command to the CC 30.

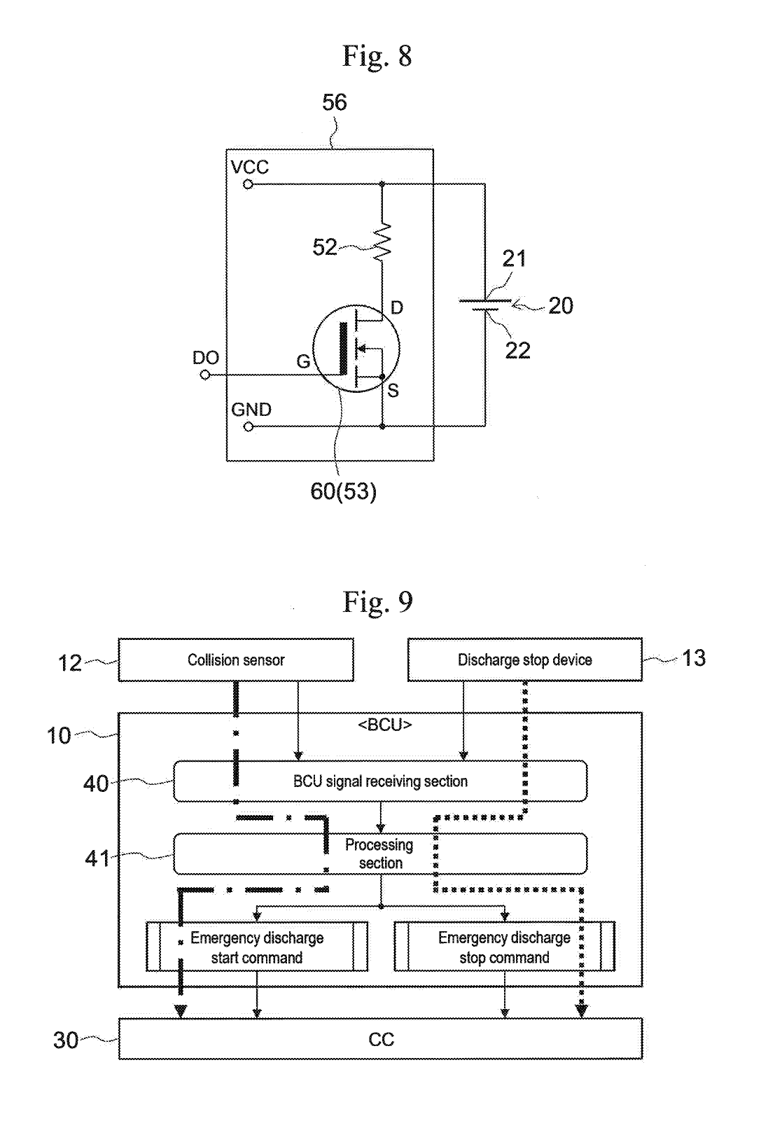

FIG. 8 illustrates an example of the resistance circuit illustrated in FIG. 6. In the example illustrated in FIG. 8, the closed state and the open state of the discharge switch 53 are achieved with use of a MOSFET 60 as the discharge switch 53.

In the example illustrated in FIG. 8, a VCC is connected with the positive electrode 21 of the secondary battery cell 20 and a GND is connected with the negative electrode 22 of the secondary battery cell 20. Each of the VCC and the GND is connected with a power source circuit (not illustrated) of the CC 30. A source S of the MOSFET 60 is connected with the negative electrode 22 of the secondary battery cell 20. A drain D of the MOSFET 60 is connected with the positive electrode 21 of the secondary battery cell 20 via the discharge resistor 52. A gate G of the MOSFET 60 is connected with a digital output port DO that is provided in the CC 30. If voltage is applied to the gate G of the MOSFET 60, current passes through the positive electrode 21 of the secondary battery cell 20, the discharge resistor 52, the MOSFET 60, and then the negative electrode 22 of the secondary battery cell 20 in this order. Thus, discharging the secondary battery cell 20 is performed.

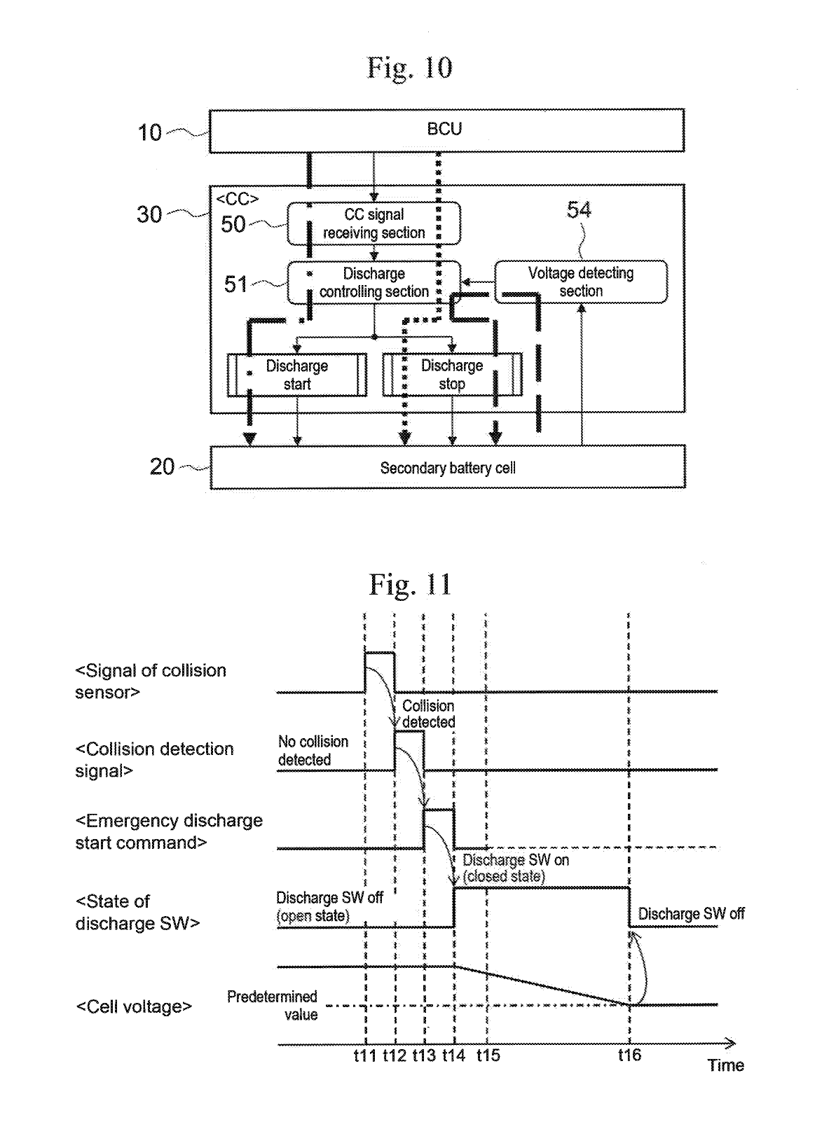

Each of FIG. 9 and FIG. 10 schematically illustrates a flow of signal processing by the BCU and the CC illustrated in FIG. 4.

If the BCU signal receiving section 40 of the BCU 10 receives a signal output from the collision sensor 12 and detects a collision of the movable object 1 in accordance with the signal, the BCU signal receiving section 40 sends a collision detection signal to the processing section 41. The processing section 41 sends an emergency discharge start command to the CCs 30 of the secondary batteries 15 in accordance with the collision detection signal (a route shown by a dashed line in FIG. 9).

Further, if, for example, the driver, the worker or the like operates the discharge stop switch 46 of the discharge stop device 13 (see FIG. 5), the BCU signal receiving section 40 of the BCU 10 receives a discharge stop signal output from the discharge stop device 13 and sends the discharge stop signal to the processing section 41. The processing section 41 sends an emergency discharge stop command to the CCs 30 of the secondary batteries 15 in accordance with the discharge stop signal (a route shown by a dotted line in FIG. 9).

If the CC signal receiving section 50 of the CC 30 of each of the secondary batteries 15 receives the emergency discharge start command from the BCU 10, the discharge controlling section 51 of the CC 30 brings the discharge switch 53 of the resistance circuit 56 to the closed state to start discharge of the secondary battery cell 20 (a route shown by a dashed line in FIG. 10).

If the CC signal receiving section 50 of the CC 30 of each of the secondary batteries 15 receives the emergency discharge stop command from the BCU 10, the discharge controlling section 51 of the CC 30 brings the discharge switch 53 of the resistance circuit 56 to the open state to stop the discharge of the secondary battery cell 20 (a route shown by a dotted line in FIG. 10).

Moreover, the voltage detecting section 54 of the CC 30 periodically detects a cell voltage of the secondary battery cell 20. If the cell voltage of the secondary battery cell 20 becomes the predetermined value or less after start of discharge of the secondary battery cell 20, the discharge controlling section 51 of the CC 30 brings the discharge switch 53 of the resistance circuit 56 to the open state to stop the discharge of the secondary battery cell 20 (a route shown by a broken line in FIG. 10).

FIG. 11 illustrates an example of discharge processing of the secondary battery cell in time series in a case where a collision of the movable object is detected. FIG. 11 illustrates a signal of the collision sensor, a collision detection signal, an emergency discharge start command, a state of the discharge switch and a cell voltage of the secondary battery cell in time series, in this order from the top.

As illustrated, a collision of the movable object 1 makes a signal of the collision sensor 12 large at time t11 and the BCU 10 detects an actual collision of the movable object 1 (e.g., collision rendering the movable object 1 unable to travel) in accordance with the signal at time t12. In such case, the BCU 10 sends an emergency discharge start command to the CC 30 at time t13.

The CC 30 having received the emergency discharge start command brings the discharge switch 53 of the resistance circuit 56 to the closed state to start discharge of the secondary battery cell 20 at time t14. After the start of discharge of the secondary battery cell 20, the cell voltage of the secondary battery cell 20 gradually decreases. At time t15, fir example, even if impact of the collision or the like interrupts communication from the BCU 10 to the CC 30, the CC 30 continues discharging the secondary battery cell 20. At time t16, if decrease in the cell voltage of the secondary battery cell 20 to a predetermined value (e.g., V) is detected, the CC 30 brings the discharge switch 53 of the resistance circuit 56 to the open state to stop the discharge of the secondary battery cell 20. Thus, the CC 30 keeps the cell voltage of the secondary battery cell 20 higher than the predetermined value.

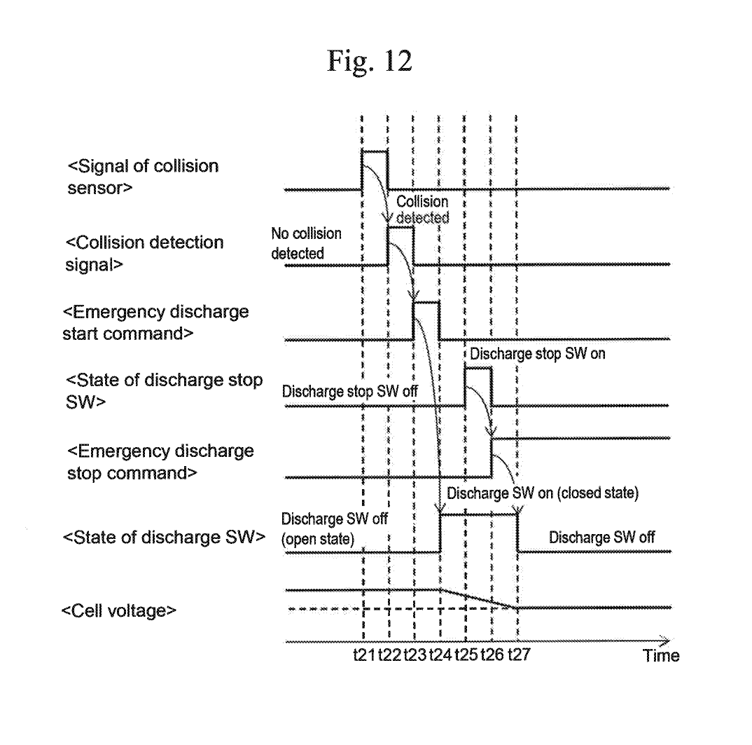

FIG. 12 illustrates another example of discharge processing of the secondary battery cell in time series in a case where a collision of the movable object is detected. FIG. 12 illustrates a signal of the collision sensor, a collision detection signal, an emergency discharge start command, a state of the discharge stop switch, an emergency discharge stop command, a state of the discharge switch, and a cell voltage of the secondary battery cell in time series, in this order from the top.

As illustrated, a collision of the movable object 1 makes a signal of the collision sensor 12 large at time t21 and the BCU 10 detects an actual collision of the movable object 1 (e.g., collision rendering the movable object 1 unable to travel) in accordance with the signal at time t22. In such case, the BCU 10 sends an emergency discharge start command to the CC 30 at time t23.

At time t24, the CC 30 having received the emergency discharge start command brings the discharge switch 53 of the resistance circuit 56 to the closed state to start discharge of the secondary battery cell 20. After the start of discharge of the secondary battery cell 20, the cell voltage of the secondary battery cell 20 gradually decreases. It for example, the driver, the worker or the like turns on the discharge stop switch 46 of the discharge stop device 13 at time t25, the BCU 10 sends an emergency discharge stop command to the CC 30 at time t26.

At time t27, the CC 30 having received the emergency discharge stop command brings the discharge switch 53 of the resistance circuit 56 to the open state to stop the discharge of the secondary battery cell 20. Thus, the CC 30 keeps the cell voltage of the secondary battery cell 20 to prevent the cell voltage from decreasing further.

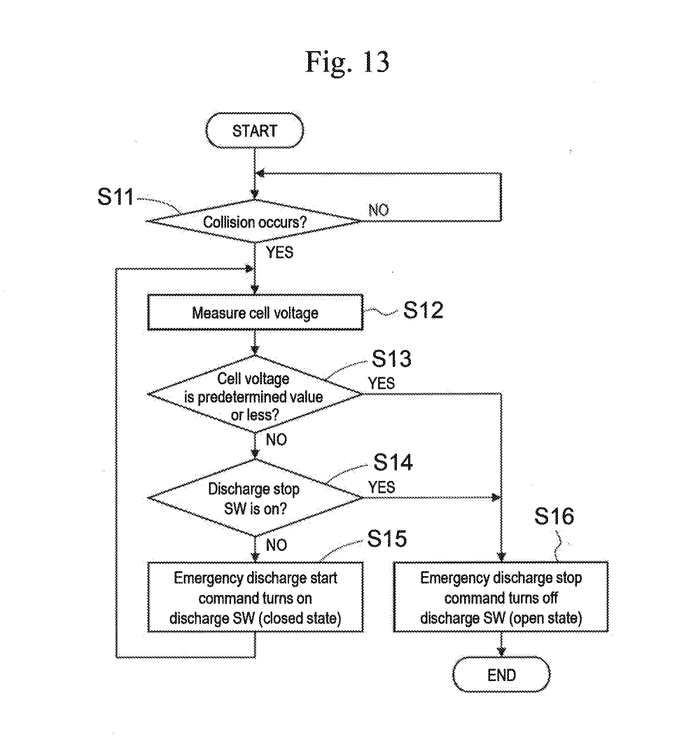

FIG. 13 illustrates more specifically a flow of the discharge processing of the secondary battery cell.

The BCU 10 determines whether a collision of the movable object 1 has actually occurred based on, for example, a signal output from the collision sensor 12 (S11). If the BCU 10 determines that a collision of the movable object 1 has actually occurred, the CC 30 of each of the secondary batteries 15 measures the cell voltages of the corresponding secondary battery cell 20 (S12).

The CC 30 of each of the secondary batteries 15 determines whether the cell voltage of the corresponding secondary battery cell 20 is not more than a predetermined value (S13). If the cell voltage of the corresponding secondary battery cell 20 is not more than the predetermined value (e.g., 2 V), the CC 30 brings the discharge switch 53 of the resistance circuit 56 to the open state to stop discharge of the secondary battery cell 20 (S16).

If the cell voltage of the corresponding secondary battery cell 20 is more than the predetermined value, the BCU 10 determines whether the discharge stop switch 46 of the discharge stop device 13 is on (S14). If the discharge stop switch 46 of the discharge stop device 13 is on, the BCU 10 sends an emergency discharge stop command to the CC 30. The CC 30 brings the discharge switch 53 of the resistance circuit 56 to the open state in accordance with the emergency discharge stop command to stop discharge of the secondary battery cell 20 (S16).

If the discharge stop switch 46 of the discharge stop device 13 is not on (in off state), the BCU 10 sends an emergency discharge start command to the CC 30. The CC 30 brings the discharge switch 53 of the resistance circuit 56 to the closed state in accordance with the emergency discharge start command to start discharge of the secondary battery cell 20 (S15).

Since a cell voltage of the secondary battery cell 20 gradually decreases after start of discharge of the secondary battery cell 20, the CC 30 periodically measures the cell voltage of the corresponding secondary battery cell 20 (S12). If the cell voltage of the corresponding secondary battery cell 20 becomes a predetermined value or less, the CC 30 brings the discharge switch 53 of the resistance circuit 56 to the open state to stop the discharge of the secondary battery cell 20 (S16). Further, if the discharge stop switch 46 of the discharge stop device 13 is turned on after start of discharge of the secondary battery cell 20, the CC 30 also brings the discharge switch 53 of the resistance circuit 56 to the open state to stop the discharge of the secondary battery cell 20 (S16).

In Embodiment 1, as described above, if a collision of the movable object 1 is detected by the collision sensor 12 arranged in the movable object 1, the BCU 10 of the battery module 11 mounted on the movable object 1 sends an emergency discharge start command to the CCs 30 of the secondary batteries 15 to discharge the corresponding secondary battery cells 20. Accordingly, at a time of detection of a collision of the movable object 1, energy of the secondary battery cell. 20 can be decreased quickly without fail.

The CC 30 is supplied with driving power by the corresponding secondary battery cell 20. The CC 30 maintains the closed state of the discharge switch 53 of the resistance circuit 56 until the CC 30 receives an emergency discharge stop command from the BCU 10. Accordingly, discharge of the secondary battery cell 20 can be continued and energy of the secondary battery cell 20 can be decreased without fail, even if, for example, impact of a collision damages the BCU 10 or disconnects a wiring connecting the BCU 10 and the secondary battery 15.

### Embodiment 2

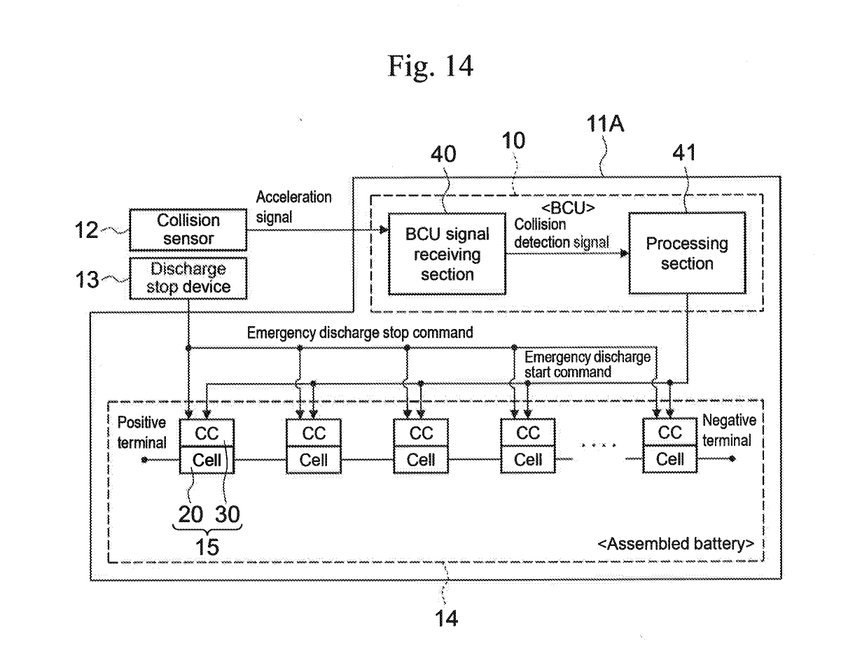

FIG. 14 illustrates an internal structure of a secondary battery module of Embodiment 2 of the present invention. A secondary battery module 11A of Embodiment 2 illustrated in FIG. 14 differs from the above Embodiment 1 in a flow of signal processing of a signal sent by the discharge stop device. The other components of Embodiment 2 are substantially same as those of Embodiment 1. Thus, the same component as Embodiment 1 is denoted by a same reference character. The detailed descriptions thereof are omitted.

In Embodiment 2, in accordance with a switch operation by, for example, a driver, a worker or the like, the discharge stop device 13 sends an emergency discharge stop command directly to the CCs 30 of the secondary batteries 15. If the CC signal receiving section 50 of the CC 30 receives the emergency discharge stop command from the discharge stop device 13, the discharge controlling section 51 brings the discharge switch 53 of the resistance circuit 56 to the open state to stop discharge of the corresponding secondary battery cell 20.

In Embodiment 2, as described above, an emergency discharge stop command for stopping discharge of the secondary battery cell 20 is sent from the discharge stop device 13 to the CCs 30 of the secondary batteries 15 without passing through the BCU 10. Accordingly, discharge of the secondary battery cell 20 can be stopped quickly without fail, even if for example, impact of a collision damages the BCU 10 or disconnects a wiring connecting the BCU 10 and the secondary battery 15.

### Embodiment 3

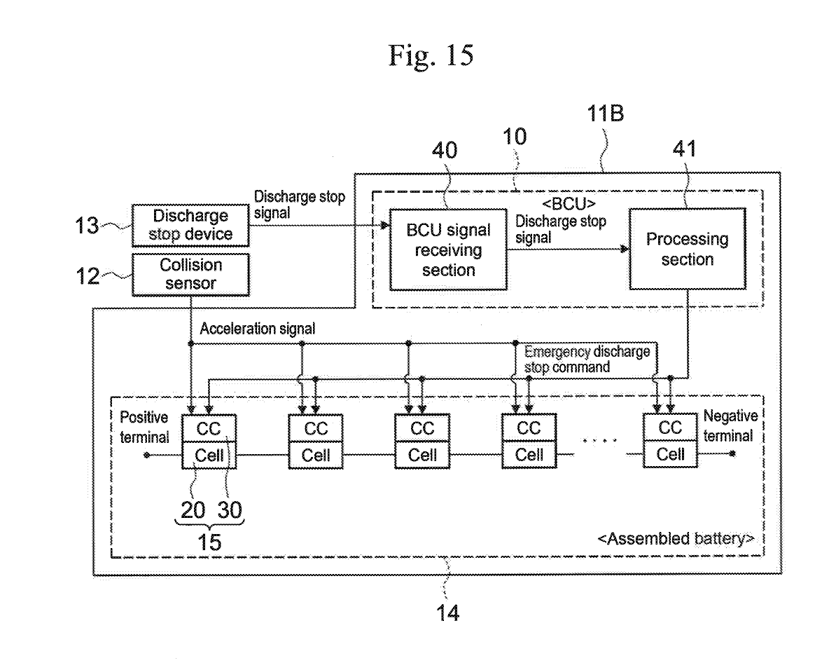

FIG. 15 illustrates an internal structure of a secondary battery module of Embodiment 3 of the present invention. A secondary battery module 11B of Embodiment 3 illustrated in FIG. 15 differs from the above Embodiment 1 in a flow of signal processing of a signal sent by the collision sensor. The other components of Embodiment 3 are substantially same as those of Embodiment 1. Thus, the same component as Embodiment 1 is denoted by a same reference character. The detailed descriptions thereof are omitted.

In Embodiment 3, a signal output from the collision sensor 12 (e.g., acceleration signal) is sent to the CC signal receiving section 50 of the CC 30 of each of the secondary batteries 15 without passing through the BCU 10. The CC signal receiving section 50 of the CC 30 determines whether a collision of the movable object 1 (e.g., collision rendering the movable object 1 unable to travel) has occurred based on the signal sent by the collision sensor 12. If the CC signal receiving section 50 of the CC 30 determines that a collision of the movable object 1 has occurred, the discharge controlling section 51 of the CC 30 brings the discharge switch 53 of the resistance circuit 56 to the closed state to start discharge of the secondary battery cell 20.

In Embodiment 3, as described above, a signal output from the collision sensor 12 is sent directly to the CC signal receiving section 50 of the CC 30 and the CC signal receiving section 50 of the CC 30 determines, for example, a collision of the movable object 1. Accordingly, the configuration of the BCU 10, for example, can be simplified. Furthermore, discharge of the secondary battery cell 20 can be started without fail to decrease energy of the secondary battery cell 20, even if the BCU 10 has damage before the collision of the movable object 1 or impact of the collision instantaneously damages the BCU 10.

### Embodiment 4

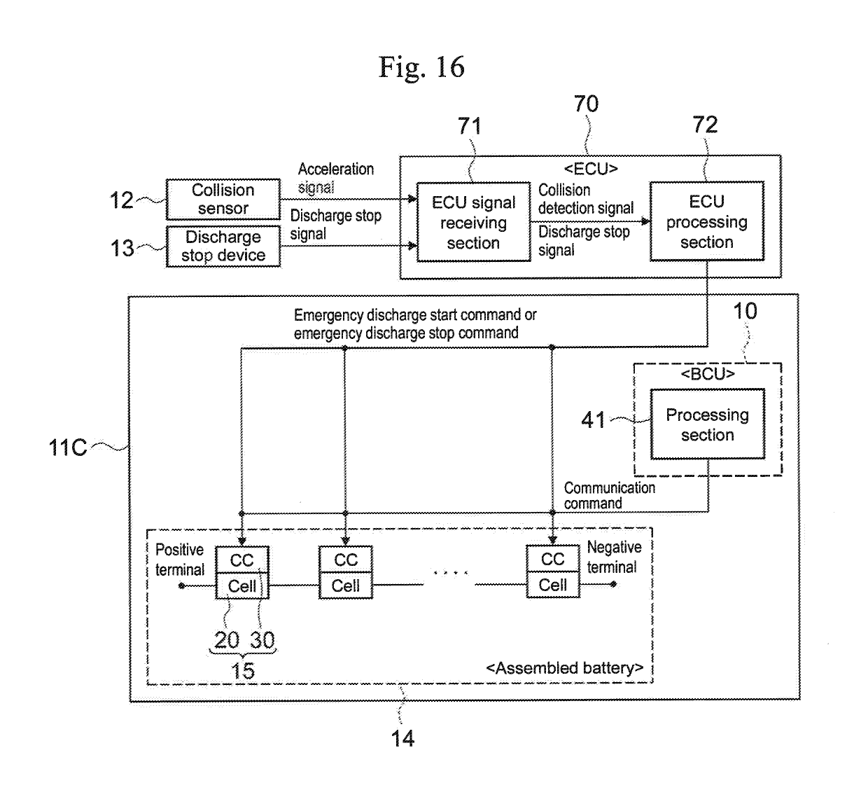

FIG. 16 illustrates an internal structure of a secondary battery module of Embodiment 4 of the present invention. A secondary battery module 11C of Embodiment 4 illustrated in FIG. 16 differs from the above Embodiment 1 in a flow of signal processing. The other components of Embodiment 4 are substantially same as those of Embodiment 1. Thus, the same component as Embodiment 1 is denoted by a same reference character. The detailed descriptions thereof are omitted.

In Embodiment 4, a signal output from the collision sensor 12 (e.g., acceleration signal) or a discharge stop signal output from the discharge stop device 13 in accordance with a switch operation by, for example, a driver, a worker or the like is sent to an engine control unit (ECU) 70 that is separate from the BCU 10.

An ECU signal receiving section 71 of the ECU 70 receives a signal from the collision sensor 12 and determines whether a collision of the movable object 1 has occurred based on the signal. If the ECU signal receiving section 71 determines that a collision of the movable object 1 has occurred, the ECU signal receiving section 71 sends a collision detection signal to an ECU processing section 72. The ECU processing section 72 having received the collision detection signal from the ECU signal receiving section 71 sends an emergency discharge start command to the CCs 30 of the secondary batteries 15. The CCs 30 having received the emergency discharge start command from the ECU signal receiving section 71 start discharge of the corresponding secondary battery cells 20.

The ECU signal receiving section 71 of the ECU 70 receives a discharge stop signal from the discharge stop device 13 and sends the discharge stop signal to the ECU processing section 72. The ECU processing section 72 having received the discharge stop signal from the ECU signal receiving section 71 sends an emergency discharge stop command to the CCs 30 of the secondary batteries 15. The CCs 30 having received the emergency discharge stop command from the ECU processing section 72 stop discharge of the corresponding secondary battery cells 20.

The BCU 10 included in the secondary battery module 11C acquires a battery temperature or a current value of the battery module 11C, a cell voltage of each secondary battery cell 20, and the like.

In Embodiment 4, as described, above, an emergency discharge start command for starting discharge of the secondary battery cell 20 or an emergency discharge stop command for stopping discharge of the secondary battery cell 20 is sent to the CCs 30 of the secondary batteries 15 via a control unit (e.g., ECU) that is separate from the BCU 10 included in the secondary battery module 11C. Accordingly, discharge of the secondary battery cell 20 can be started without fail and discharge of the secondary battery cell 20 can be stopped without fail, even if, for example, the BCU 10 has damage before the collision of the movable object 1, impact of the collision damages the BCU 10 or disconnects a wiring connecting the BCU 10 and the secondary battery 15.

A communication command such as an emergency discharge start command and an emergency discharge stop command is normally sent from the BCU 10 to the CCs 30 of the secondary batteries 15. If, for example, impact of a collision damages the BCU 10 or disconnects a wiring connecting the BCU 10 and the secondary battery 15, an emergency discharge start command or an emergency discharge stop command is sent from a control unit that is separate from the BCU 10 to the CCs 30 of the secondary batteries 15. Thus, discharge of the secondary battery cell 20 can be started without fail and discharge of the secondary battery cell 20 can be stopped without fail.

The aforementioned Embodiments 1 to 4 describe an embodiment in which the collision sensor 12 comprising, for example, an acceleration sensor is used to detect a collision of the movable object. However, if the movable object mounts a collision predicting device comprising, for example, a vehicle-mounted camera and a vehicle speed sensor, the collision predicting device may be used to detect a collision probability of the movable object and an emergency discharge start command is sent to the CCs 30 of the secondary batteries 15 in accordance with the detected collision probability to cause discharge of the corresponding secondary battery cells 20. Further, after the collision predicting device detects a collision probability of the movable object to cause discharge of the secondary battery cells 20, it may be determined that no actual collision of the movable object has occurred or an actual collision is smaller than predicted (for example, the movable object is able to travel). In this case, an emergency discharge stop command may be sent to the CCs 30 of the secondary batteries 15 to stop the discharge of the corresponding secondary battery cells 20.

The aforementioned Embodiments 1 to 4 describe an embodiment in which discharge of the secondary battery cell 20 is stopped in accordance with an operation of the discharge stop switch 46 by a driver, a worker or the like. However, another vehicle-mounted control unit or the like, for example, may determine a state of each secondary battery cell 20, operate the discharge stop switch 46 in accordance with the determination result and stop discharge of the secondary battery cell 20.

The aforementioned Embodiments 1 to 4 describe an embodiment in which the MOSFET 60 is used as the discharge switch 53 of the resistance circuit 56. However, examples of the discharge switch 53 include another transistor, IGBT and electromagnetic relay.

The aforementioned Embodiments 1 to 4 describe an embodiment in which the resistance circuit 56 is used to discharge the secondary battery cell 20. However, a power generating element or an FET may be used instead of the resistance circuit 56.

Further, the number and connection form (series or parallel connection) of the secondary batteries 15 included in the assembled battery 14 may be altered as appropriate in accordance with required performance of a secondary battery module.

The present invention is not limited to the aforementioned Embodiments 1 to 4. The present invention includes various modifications. For example, the aforementioned Embodiments 1 to 4 are described in detail to make the present invention easy to understand. Thus, the present invention is not necessarily limited to an embodiment including all described configurations. Part of one of the embodiments can be replaced with a configuration of another of the embodiments. A configuration of one of the embodiments can be added to a configuration of another of the embodiments. Part of a configuration of each embodiment can be added to another configuration, be deleted, or be replaced with another configuration.

Part or whole of the aforementioned configurations, functions, processing sections, processing means and the like may be implemented by hardware, for example, by being designed as an integrated circuit. The aforementioned configurations, functions and the like may be implemented by software, for example, by a processor interpreting and executing programs to implement the functions. Information of a program, a table, a file and the like for implementing the functions may be stored in a storage device such as a memory, a hard disk and an SSD (solid state drive) or in a storage medium such as an IC card, an SD card and a DVD.

The shown control lines and informative lines are considered to be necessary for the descriptions. All control lines and informative lines in a product are not necessarily shown. It could be considered that all components are connected with one another in actuality.

### REFERENCE SIGNS LIST

1 movable object
2 drive wheel
3 axle
4 differential gear
5 transmission
6 engine
7 motor generator
8 driving power switching device
9 power inverting device
10 battery control unit (BCU)
11 secondary battery module
12 collision sensor
13 discharge stop device
14 assembled battery
15 secondary battery
20 secondary battery cell
21 positive electrode
22 negative electrode
23 bus bar
24 cleavage valve
30 cell controller (CC)
31 communication connector
40 BCU signal receiving section
41 processing section
45 resistance element
46 discharge stop switch
50 CC signal receiving section
51 discharge controlling section
52 discharge resistor
53 discharge switch
54 voltage detecting section
55 CC signal sending section
56 resistance circuit
60 MOSFET
70 engine control unit (ECU)
71 ECU signal receiving section
72 ECU processing section

1-10. (canceled)

11. A secondary battery comprising: a secondary battery cell; and a cell controller controlling charge/discharge of the secondary battery cell, wherein
the cell controller causes discharge of the secondary battery cell when a collision or a collision probability of a movable object mounting the secondary battery is detected, and the cell controller stops discharge of the secondary battery cell when a discharge stop device mounted on the movable object is operated.

12. The secondary battery according to claim 11, wherein the secondary battery has a resistance circuit to discharge the secondary battery cell, and the cell controller causes discharge of the secondary battery cell by causing the resistance circuit to operate.

13. The secondary battery according to claim 11, wherein a collision or a collision probability of the movable object is detected by a collision sensor or a collision predicting device arranged in the movable object.

14. A secondary battery module comprising: an assembled battery formed of multiple secondary batteries connected with one another in series and/or in parallel; and a battery control unit controlling the assembled battery, the secondary battery including a secondary battery cell and a cell controller controlling charge/discharge of the secondary battery cell, wherein
when a collision or a collision probability of a movable object mounting the secondary battery module is detected, the battery control unit sends a discharge start command to the cell controllers of the secondary batteries included in the assembled battery and the cell controller causes discharge of the secondary battery cell of the corresponding secondary battery in accordance with the discharge start command, and
when a discharge stop device mounted on the movable object is operated, the battery control unit sends a discharge stop command to the cell controllers of the secondary batteries included in the assembled battery and the cell controller stops discharge of the secondary battery cell of the corresponding secondary battery in accordance with the discharge stop command.

15. The secondary battery module according to claim 14, wherein the discharge start command is sent from a control unit that is separate from the battery control unit to the cell controllers of the secondary batteries.

16. The secondary battery module according to claim 14, wherein the discharge stop command is sent from a control unit that is separate from the battery control unit to the cell controllers of the secondary batteries.
